(19) United States
(12) Patent Application Publication
(10) Pub. No.: US 2003/0178266 A1
(43) Pub. Date: Sep. 25, 2003

(54) BRAKE DEVICE, DISC BRAKE, DRUM BRAKE AND METHOD FOR MANUFACTURING A BRAKE DEVICE

(75) Inventors: Johan Hulten, Goteborg (SE); John Flint, Faaborg (DK)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO TRUCK CORPORATION, Goteborg (SE)

(21) Appl. No.: 10/249,254

(22) Filed: Mar. 26, 2003

Related U.S. Application Data
(63) Continuation of application No. PCT/SE01/02103, filed on Sep. 28, 2001.

(30) Foreign Application Priority Data
Sep. 28, 2000 (SE) 0003482-7

(51) Int. Cl. F16D 69/00

(52) U.S. Cl. 188/250 R; 188/73.1

(57) ABSTRACT

Method and arrangement for providing a brake device having a rear plate bearing a brake lining. The plate and lining have at least one contact surface, side edges and two end edges. A coefficient of friction of the brake lining varies in a longitudinal direction between the two end edges in such a manner that at least one of the end edges has a lower coefficient of friction than the remaining portion of the brake lining. The brake lining and the rear plate are preferably of one-piece construction.

### CROSS REFERENCE TO RELATED APPLICATIONS

The present application is a continuation patent application of International Application No. PCT/SE01/021 03 filed Sep. 28, 2001 which was published in English pursuant to Article 21(2) of the Patent Cooperation Treaty and which claims priority to Swedish Patent Application No. 0003482-7 filed Sep. 28, 000.. Both applications are expressly incorporated herein by reference in their entireties.

### BACKGROUND OF THE INVENTION

1. Technical Field

The present invention relates a brake device of the type that includes a rear plate bearing a brake lining that has at least one contact surface and side edges and end edges; more particularly, the invention relates to a brake device in which the occurrence of brake squeal can be reduced by virtue of the design of a brake lining.

2. Background Art

When vehicles are braked, what is known as brake squeal sometimes arises, which occurs in the case of both disk brakes and drum brakes. Typical frequencies of this noise lie in the range of some kHz and lie within the range of human hearing sensitivity. It is true that the sound generated decreases with distance from the sound source, but it can be as much as roughly 140 dB close to the brake. City buses that stop repeatedly within densely populated areas are especially troublesome, but brake squeal is also a common cause of complaint about new private cars, trucks, and buses. Even though brake squeal does not affect the braking effect or safety, the problem is nevertheless of great significance and merits a solution. The problem also occurs in vehicles having brake systems known as ABS brakes.

Many analyses of the problem of brake squeal have been performed, and many different solutions have been tried. Attempts have been made, for example, to dimension components in the brake system in order to bring about a change in the natural frequency of the system, but these attempts have not been successful in sufficiently reducing the occurrence of brake squeal of such modified brake systems.

U.S. Pat. No. 5,145,037, for example, discloses a disk brake in which it is intended to reduce the occurrence of brake squeal by virtue of end areas of the brake disk being chamfered within an area of which the extent is dependent on the width between claws forming part of a brake caliper, which claws bear a rear plate in which the brake lining is arranged. Furthermore, a disk brake is previously known from U.S. Pat. No. 4,485,989 in which it is intended to reduce brake squeal by virtue of the brake lining being provided with a portion made of a lubricating solid material that enables lubrication of the brake disk.

Although the abovementioned proposals contribute to reducing the occurrence of brake squeal under certain conditions, these solutions do not contribute to reducing the occurrence of brake squeal when varying load is applied to the brake device. Problems may also arise in a disk brake with an arrangement for lubricating the brake disk owing to the fact that the braking capacity is initially reduced more than normal when cold and/or wet.

### SUMMARY OF INVENTION

One objective of the present invention is to provide a brake device in which the occurrence of brake squeal under varying load applied to the brake device is reduced. This object is achieved by means of a brake device having a rear plate bearing a brake lining which has at least one contact surface and side edges and end edges. A coefficient of friction of the brake lining varies in the longitudinal direction between the two end edges in such a manner that at least one of the end edge portions of the brake lining has a lower coefficient of friction than the remaining part of the brake lining. In a particularly preferred embodiment, the brake lining and the rear plate constitute one piece. In related embodiments, the device can take the form of a disk brake and/or a drum brake.

In still a further embodiment, the invention may alternatively take the form of a method for manufacturing such a brake device having a brake lining and a rear plate which includes the steps of manufacturing the brake lining from two or more friction materials so that its coefficient of friction varies in the longitudinal direction between the two end edges of the brake lining, and fixing the brake lining to the rear plate.

### BRIEF DESCRIPTION OF DRAWINGS

The invention will be described in greater detail below with reference to the accompanying figures of the drawing, in which:

FIG. 1 is a curve chart in which the units frequency f and coefficient of friction (mu) the phenomenon of coupling of split modes;

FIG. 2 is a side view of a brake lining according to the invention; and

FIG. 3 is an alternative embodiment of a brake lining according to FIG. 2.

### DETAILED DESCRIPTION

In An Assumed Modes Method Approach to Disc Brake Squeal Analysis, Society of Automotive Engineers, 1999-01-1335, by Hulten and Flint, an exemplary theory is explored and it emerges that, on account of the rotational symmetry of a brake device, for example a brake disk, two modes exist for each natural frequency of the brake device. When a mode pair exists for a natural frequency, a wave can propagate through the brake device if excitation energy is supplied, in which case noise, what is known as brake squeal, can arise. When a brake lining interconnects a brake disk, or alternatively a brake drum and a brake lining, the coupled modes are split up into separate natural frequencies for the system. Non-conservative forces, such as friction forces for example, tend to couple these freestanding modes and combine them into common natural frequency, in which case brake squeal can arise.

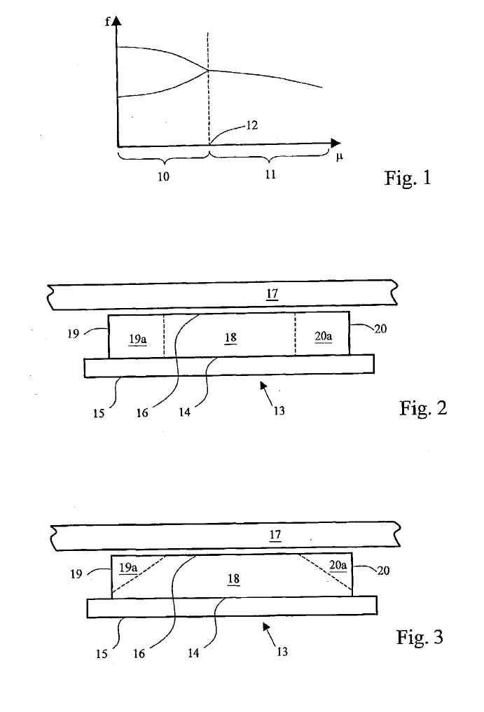

In order to avoid brake squeal from occurring, the system thus needs to be designed so that separation of a set of modes, which principally have natural frequencies between 1 and 15 kHz, can be maintained. Because of the coupling, the occurrence of brake squeal can thus arise from a number of different natural frequencies and is thus dependent on the interaction between the lining and the brake device, whether it be of the disk or drum type. In order to reduce the risk of brake squeal from arising for the majority of natural frequencies, preferably all natural frequencies within the abovementioned range, it is important that the interaction between the lining and the disk or drum takes place in a predictable manner. FIG. 1 illustrates a situation in which an increase in the coefficient of friction gives rise to a coupling together of split modes, in which case a transition takes place from a stable state 10 to an unstable state 11 at a point 12 that corresponds to a critical level of the coefficient of friction. By virtue of the invention, this point 12 can be moved to a higher level, that is to say, to the right along the (mu) axis of the diagram.

FIG. 2 shows a side view of a brake device 13 configured according to the invention. The brake device is arranged so as to interact in a known manner with a brake disk 17 or a brake drum by virtue of means that are not shown, but which are well known to the person skilled in the art. Examples of the interaction and the necessary component means for providing a functioning brake are exemplified in U.S. Pat. No. 5,145,037 and GB 2143916 for a disk brake configuration of the present invention and SE 504 272 shows an example of a drum brake application of the invention.

The brake device 13 comprises (includes) a brake lining 14 and a rear plate 15. The brake lining 14 and the rear plate 15 are preferably made in one piece. Alternatively, the brake lining can be fixed to the rear plate in a manner well known to the person skilled in the art. The brake lining constitutes a wearing surface when the brake device is used for braking, and the rear plate distributes the pressing force from brake cylinders (not shown) to the brake lining when the brake device is utilized as a brake. An example of a design of such a brake that utilizes brake cylinders is exemplified in U.S. Pat. No. 5,145,037.

In a disk brake arrangement, the brake device is plane; that is to say, a plane lining is fixed to a plane rear plate. In a drum brake arrangement, the brake device is convex; that is to say, a convex brake lining is fixed to the outside of a semicircular rear plate. The brake device is advantageously designed so that it fits existing brake arrangements in vehicles in a manner that it can readily be used as an exchange component on existing brake arrangements.

The brake lining has a contact surface 16 which is intended to be pressed against a brake disk 17 or, as the case may be, against a brake drum. The lining also has side edges 18 and edges 19, 20. According to the invention, the brake lining 14 is configured so that the coefficient of friction varies in the longitudinal direction between the two end edges 19, 20 in such a manner that at least one of the end edge portions 19a, 20a of the brake lining has a lower coefficient of friction than the remaining part of the brake lining. This variation can take place either gradually along the end edge portion, or in a stepped manner in the border portion between the end edge portion and the remaining part of the brake lining. This variation can take place at either end edge or at both end edges. The difference in the coefficient of friction between this end portion and the remaining part of the brake lining is suitably at least roughly or approximately (both terms should be interpreted to mean not necessarily exactly, but substantially) five percent (5%).

According to an advantageous variant of the invention, the difference in the coefficient of friction is at least ten percent (10%). According to another advantageous variant of the invention, the difference in the coefficient of friction is at least 15%. According to another advantageous variant of the invention, the difference in the coefficient of friction is at least 20%.

The length of the end portion 19a, 20a is suitably between 5 and 40% of the total distance between the end edges 19, 20. According to an advantageous variant of the invention, the length of the end portion is suitably between 10 and 30% of the total distance between the end edges 19, 20. The variation in the coefficient of friction does not have to be limited to the end edge portions 19a, 20a, but can also be distributed over the entire length of the brake lining so that one end edge has a lower coefficient of friction than the other. In this connection, the variation in the coefficient of friction can take place in a stepped or continuous manner.

FIG. 3 shows a side view of an alternative embodiment of a brake device 13 according to the invention. As described above, at least one of the end edge portions 19a, 20a of the brake lining has a lower coefficient of friction than the remaining part of the brake lining. In this case, the border portion is not vertical in the brake lining, but the border portion is inclined. The inclination is such that the extent of the end edge portions 19a, 20a is greater at the contact side 16 of the brake lining and decreases in the direction toward the rear plate 15. The inclination can be such that the end edge portions 19a, 20a stop somewhere along the end edges as shown in FIG. 3, or such that the end edge portions 19a, 20a stop somewhere along the rear plate 15. This variation can take place either gradually along the end edge portion, or in a stepped manner in the border portion between the end edge portion and the remaining part of the brake lining. This variation can take place at either end edge or at both end edges. As the brake lining wears, that is to say as the brake lining 14 becomes thinner, the brake arrangement 13 becomes more rigid, which reduces the risk of brake squeal. This means that the extent of the end edge portions, which have a lower coefficient of friction than the remaining part of the brake lining, can decrease as the brake lining becomes thinner. The advantage of this design is therefore that it maximizes the braking properties of the brake lining without brake squeal arising.

The brake lining and the rear plate are manufactured from materials well known to the person skilled in the art.

In an alternative aspect, the invention takes the form of a method for manufacturing a brake device having a rear plate bearing a brake lining and which has at least one contact surface and side edges and end edges. The brake lining is designed so that its coefficient of friction varies in the longitudinal direction between the two end edges 19, 20.

For manufacturing the brake device, the brake lining is formed first, from various friction materials. In order for the brake lining to be as homogeneous as possible, the brake lining and the end edge portions 19a, 20a of the brake lining are formed in the same process. This process, which is well known to the person skilled in the art, is similar to that for manufacturing brake linings made of one material and can be based on, for example, molding, extrusion or pressing. In this process, the component friction materials are applied simultaneously via separate nozzles. The brake lining is then finished in a manner well known to the person skilled in the art. The linings are often manufactured in larger units, for example, which are then sawn into disks. Grooves can also be milled into the linings. The lining is then fixed to the rear plate in a manner well known to the person skilled in the art, by means of, for example, a suitable adhesive.

The invention can be used for a variety of types of disk brakes and drum brakes that are well known to the person skilled in the art.

1. A brake device comprising:
a rear plate bearing a brake lining having at least one contact surface, side edges and two end edges;
a coefficient of friction of the brake lining varies in a longitudinal direction between the two end edges in such a manner that at least one of the end edges has a lower coefficient of friction than the remaining portion of the brake lining; and
the brake lining and the rear plate are of one-piece construction.

2. The brake device as recited in claim 1, wherein the variation in the coefficient of friction of the brake lining takes place gradually in an end edge portion thereof between one of the two end edges and the remaining portion of the brake lining.

3. The brake device as recited in claim 1, wherein the variation the variation in the coefficient of friction of the brake lining takes place, in a stepped manner, in a border portion between one of the two end edges and the remaining portion of the brake lining.

4. The brake device as recited in claim 1, wherein the variation the variation in the coefficient of friction of the brake lining takes place, in a stepped manner, and so that one of the two end edges has a lower coefficient of friction than the other.

5. The brake device as recited in claim 1, wherein the variation the variation in the coefficient of friction of the brake lining takes place gradually so that one of the two end edges has a lower coefficient of friction than the other.

6. The brake device as recited in claim 1, wherein the difference in the coefficient of friction between the two end edges is at least approximately five percent.

7. The brake device as recited in claim 1, wherein the difference in the coefficient of friction between the two end edges is at least approximately ten percent.

8. The brake device as recited in claim 1, wherein the difference in the coefficient of friction between the two end edges is at least approximately fifteen percent.

9. The brake device as recited in claim 1, wherein the difference in the coefficient of friction between the two end edges is at least approximately twenty percent.

10. The brake device as recited in claim 2, wherein the length of the end portion is between five and forty percent of the distance between the two end edges.

11. The brake device as recited in claim 2, wherein the length of the end portion is between ten and thirty percent of the distance between the two end edges.

12. The brake device as recited in claim 2, wherein the brake device is incorporated into a disk brake assembly.

13. The brake device as recited in claim 2, wherein the brake device is incorporated into a drum brake assembly.

14. A method for manufacturing a brake device comprising:
providing a brake device having a brake lining and a rear plate;
manufacturing the brake lining from two or more friction materials so that its coefficient of friction varies in the longitudinal direction between two end edges of the brake lining; and
fixing the brake lining to the rear plate.
